(19) United States
(12) Patent Application Publication
(10) Pub. No.: US 2008/0062987 A1
(43) Pub. Date: Mar. 13, 2008

(54) Method and system for wireless VoIP communications

(75) Inventor: George F. Elmasry, Farmingdale, NJ (US)

Correspondence Address: CATALINA & ASSOCIATES;A Professional Corporation, 2355 HIghway 33, Robbinsville, NJ, 08691, US

(73) Assignee: D & S Consulting, Inc.

(21) Appl. No.: 11/518,705

(22) Filed: Sep. 11, 2006

(51) Int. Cl. H04L 12/56

(52) U.S. Cl. 370/392

(57) ABSTRACT

Methods, an apparatus, and a system for communications using datagrams including payloads of at least one preceding datagram are disclosed. In particular, the invention may advantageously be used in wireless VoIP networks having high rates of packet losses.

### FIELD OF THE INVENTION

The present invention generally relates to the field of digital communications and, in particular, to wireless Voice-over-Internet-Protocol (“VoIP”) communications over networks having high rates of packet losses. More particularly, the present invention recovers lost packets of digital communications, in real-time, to produce acceptable quality voice even with high packet loss.

### BACKGROUND OF THE INVENTION

Military and commercial networks may have communication links that exhibit high rates of packet losses during periods of excessive fading, jitter, or delay of the transmitted signals. During such periods, the performance of voice or data communications may fall below acceptable levels.

For tactical wireless ad-hoc IP based networks, such as Future Combat Systems (FCS), links can be unreliable and can suffer from intermediate periods of fading causing large packet loss thereby causing performance degradation of VoIP communications. This raises the need and desire to boost the performance of these applications in a way that VoIP decoders see less packet loss than actually introduced by the network, all without increasing the number of packets entering the network.

One important advantage of the present invention, as demonstrated below, is that it does not increase the number of packets entering the network, an important consideration for Type I encryption or High Assurance Internet Protocol Encryption (“HAIPE”), where the ratio of payload to overall packet is small. Rather, the invention expands the packet size slightly by increasing only the payload size with no overhead.

VoIP boosting techniques for tactical networks need to consider the effects and constraints of HAIPE. In such wireless VoIP networks, packet losses may be caused by, for example, the movement of the transmitting or the receiving terminals, electro-magnetic interference, changes in environmental conditions, and other such factors. In networks utilizing HAIPE, in which packet size is substantially increased as a result of the encryption, the decryption technique checks for bit error. If any error in the packet is discovered, HAIPE drops the entire packet. In such encryption systems, packets with any missing or corrupted data are intentionally dropped or discarded by the encryption protocol, resulting in significantly higher packet losses than would occur without encryption. As a result, this behavior causes a HAIPE encrypted VoIP network to introduce more packet loss to the VoIP stream. VoIP “boosting techniques” for tactical networks, therefore, must be able to deal with the effects and constraints that such encryption techniques impose on packet transfer.

Various error cancellation methods and forward error correction (FEC) techniques have been used to decrease unrecoverable losses or corruption of the packets entering a wireless VoIP network as described in, for instance, U.S. Pat. No. 6,785,261 issued to Schuster, et al. on Aug. 31, 2004 entitled “Method and system for forward error correction with different frame sizes,” the contents of which are hereby incorporated by reference. Other correction methods include relying on interpolating a missing packet based on adjacent packets as described in, for instance, U.S. Pat. No. 6,981,193 issued to Park on Dec. 27, 2005 entitled “Internet telephone and method for recovering voice data lost therein,” the contents of which are hereby incorporated by reference. Tactical networks have more unique characteristics that require a different type of boosting. This invention does not preclude the use of FEC at the wireless link. This invention performs VoIP boosting at the IP layer and works on IP packets before encryption and after decryption.

However, despite the considerable effort in the art devoted to development of reliable wireless VoIP communications, further improvements would be desirable.

### SUMMARY OF THE INVENTION

One aspect of the invention is a method of information transfer in a packet-switched network using signal packets having a payload field and at least one field containing a copy of a payload of at least one preceding packet. At a receiving terminal, the payload fields of the signal packets are separated and their contents are selectively forwarded to a recipient application.

Another aspect of the invention is a method of digital communications comprising transmitting datagrams each including a payload and a copy of a payload of at least one preceding datagram. At a receiving terminal, the payload of a datagram and copies of the payloads of the preceding datagrams are separated, and the payload and copies of the payloads of missing preceding datagrams are forwarded to an application layer, such as, for example, a voice application.

Yet another aspect of the invention is a method of wireless voice over Internet (VoIP) communications where, at a transmitting terminal, a payload of a datagram is combined or “multiplexed” with a copy of a payload of at least one preceding datagram, and a wireless signal carrying such a datagram is transmitted. At a receiving terminal, these payloads are de-multiplexed, and the payload of the datagram and recovered copies of payloads of missing or corrupted packets are forwarded to a voice application.

Other aspects of the present invention provide terminals and systems for wireless VoIP communications implementing the inventive methods and computer readable mediums storing software that performs these methods.

The Summary is neither intended nor should it be construed as being representative of the full extent and scope of the present invention, which these and additional aspects will become more readily apparent from the detailed description, particularly when taken together with the appended drawings.

### BRIEF DESCRIPTION OF THE DRAWINGS

FIG. 1 is a high-level, schematic diagram depicting a wireless VoIP system in accordance with one embodiment of the present invention;

FIG. 2 is a schematic diagram illustrating a structure of a datagram used in the system of FIG. 1;

FIG. 3 is a high-level, schematic diagram depicting a configuration of an exemplary software stack of a terminal of the system of FIG. 1; and

FIG. 4 is a flow diagram illustrating a method of wireless VoIP communications in accordance with one embodiment of the present invention.

To facilitate understanding, identical reference numerals have been used, where possible, to designate identical elements that are common to the figures, except that suffixes may be added, when appropriate, to differentiate such elements. The images in the drawings are simplified for illustrative purposes and are not depicted to scale.

The appended drawings illustrate exemplary embodiments of the invention and, as such, should not be considered as limiting the scope of the invention that may admit to other equally effective embodiments.

### DETAILED DESCRIPTION

Herein, the present invention is illustratively discussed in the context of wireless VoIP systems. However, as readily appreciated by those skilled in the art, in other embodiments, the invention may advantageously be used in wired and fiber-optic terrestrial or undersea networks supporting packet-based voice or data communications, as well as in the networks having a combination of wireless, wired or fiber-optic links, and further including free space optical communication networks, such as a laser-based communication network.

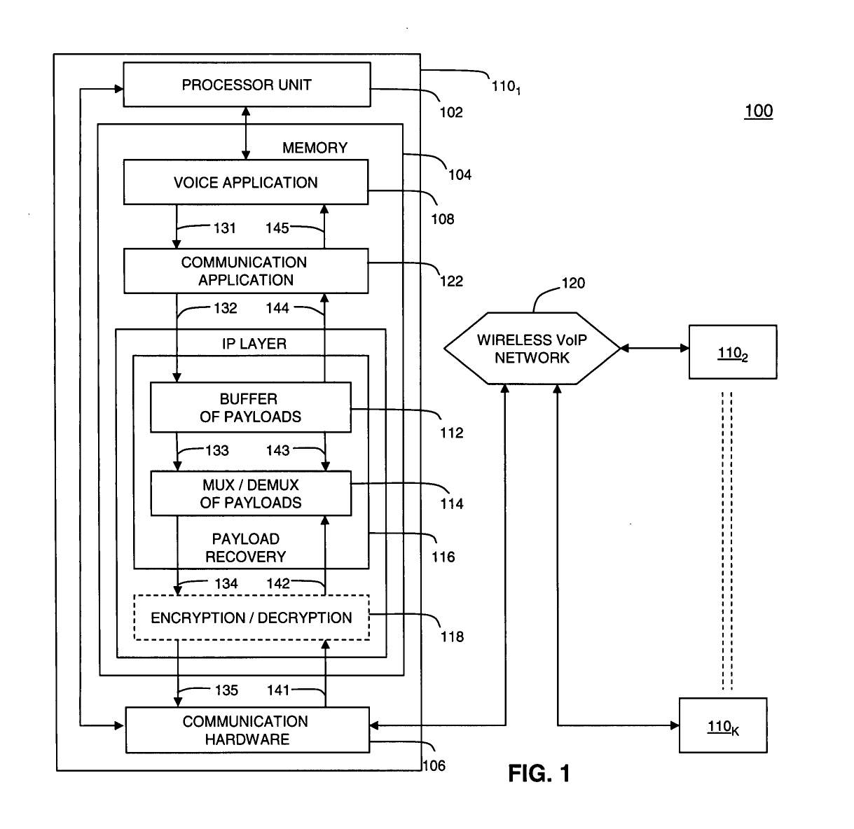

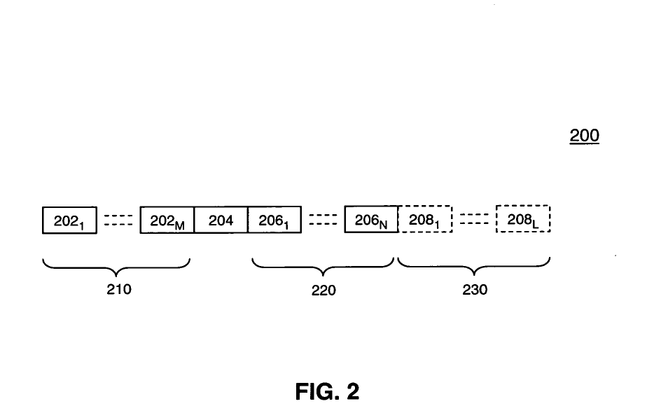

FIG. 1 is a high-level, schematic diagram depicting a wireless VoIP communication system 100 implementing one embodiment of the present invention, and FIG. 2 is a schematic diagram illustrating a structure of a datagram used in the system 100. For best understanding of this embodiment of the invention, the reader should refer simultaneously to FIGS. 1 and 2.

The system 100 comprises a plurality of terminal 110₁-110_{K} (K is an integer, and K≧2) and a wireless VoIP network 120. The terminals 110 may be stationary or mobile terminals. In the depicted embodiment, the terminals 110 are shown as integrated transmitting/receiving terminals. Alternatively or additionally, the system 100 may also comprise specialized transmitting or receiving terminals (not shown).

The system 100 supports wireless VoIP communications, which are performed between the terminals 110 in a form of discrete packets, or datagrams. In operation, the packets are wirelessly transmitted between the terminals 110. Herein, the terms “packet” and “datagram” are used interchangeably. In one embodiment, the system 100 illustratively uses a time division multiple access (TDMA) communication protocol, however, use of other communication protocols (for example, code division multiple access (CDMA) communication protocol) is contemplated and is within the scope of the present invention. In some embodiments, the network 120 and terminals 110 may use more than one communication protocol.

The terminal 110 may contemporaneously function as a transmitting terminal for some voice messages (e.g., requests of information) or a receiving terminal for other messages (e.g., responses to such requests), thereby supporting half-duplex or duplex wireless VoIP communications. As such, herein the terms “transmitting terminal” and “receiving terminal” may interchangeably be used in reference to (i) the same terminal transmitting and receiving different messages or (ii) different terminals, one of which is a source and the other is a recipient of the same message.

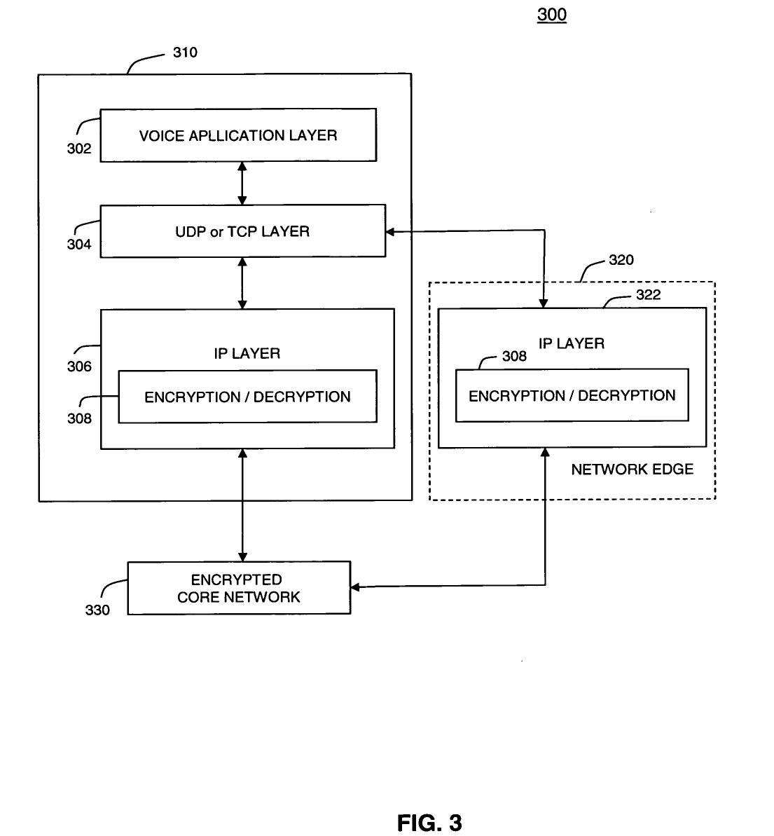

In one embodiment, a terminal 110 comprises a processor unit 102, a memory 104, and communication hardware 106. The processor unit 102 is coupled to the memory 104 and communication hardware 106. The memory 104 contains a plurality of programs which, when executed by the processor unit 102, facilitate operability of the terminal 110. In particular, the memory 104 comprises a voice application 108, a communications application 122, a payload packaging and recovery process or application 116 (the “payload recovery application 116”), and an optional encryption/decryption process, application or device 118 (the “encryption/decryption 118”). The payload recovery application 116 generally includes a buffer 112 and a component for combining/separating payloads, hereafter a multiplexer/de-multiplexer (MUX/DEMUX) 114. Alternatively, at least some elements of the payload recovery application 116 may be realized in hardware. However, in preferred embodiments of the invention, the payloads of the current and preceding datagrams, as shall be immediately discussed below, are combined or “multiplexed” at an IP layer of the terminal 110 (as shown in FIG. 1) or, alternatively, at an IP layer of a network edge (discussed in reference to FIG. 3 below). In addition, alternatively, at least some elements of the encryption/decryption 118 may be realized in hardware.

The voice application 108 digitizes outgoing voice messages and defines payloads of the packets used to transmit these messages, as well as de-digitizes content of payloads of the received packets. The encryption/decryption application 118 encrypts outgoing (i.e., to be transmitted) datagrams and, correspondingly, decrypts the received datagrams. The communication application 122 facilitates transmission of the outgoing packets and reception of the incoming packets. The communication hardware 106 collectively corresponds to physical means of the terminal 110 facilitating wireless VoIP communications and includes transmitters, receivers, and operator controls, among other devices. Arrows 131-135 and 141-145 illustrate the directions of signal flows in the terminal 110 during transmitting and receiving phases of operation, respectively. FIG. 1 is illustrative of an embodiment of the invention as incorporated into a network system. It is readily apparent to those skilled in the art that the system of FIG. 1 may be illustrated in different configurations.

FIG. 2 is a schematic diagram illustrating a structure of a datagram 200 used in the system 100. The datagram 200 comprises a plurality 210 of header fields 202₁-202_{M}, a payload field (i.e., voice data field) 204, a plurality 220 of fields 206₁-206_{N} each containing a copy of a payload of one of preceding datagrams, and an optional plurality 230 of system fields 208₁-208_{L}, where M, N, and L are integers greater than or equal to 1. In the first N datagrams of a data train corresponding to a respective voice message, some of the fields 206₁-206_{N} relate to yet non-existing preceding datagrams and, therefore, may be left blank or contain predetermined symbols or data.

In some embodiments, the datagram 200 may include, for example, the plurality 210 comprising IP (Internet) and TCP (Transmission Control Protocol) or UDP (User Data Protocol) headers, the payload field 204 and the fields 206₁-206_{N}. In embodiments that use data encryption techniques (e.g., High Assurance Internet Protocol Encryption (HAIPE)), a structure of the header fields 202₁-202_{M} is generally more complex and, additionally, the datagram 200 typically includes the system fields 208₁-208_{L}.

Using the payload recovery application 116, which, in a preferred embodiment, operates at the IP layer, the terminal 110 may process outgoing packets which payload fields include a field containing payload of a currently processed datagram (field 204) and a pre-determined number of fields containing copies of payloads of most recent preceding datagrams (fields 206₁-206_{N}). This is achieved by temporarily storing in the buffer 112 the copies of the payloads of datagrams preceding the currently processed datagram and then, using the MUX/DEMUX 114, multiplexing (i.e., combining) them with the payload of that datagram. In one embodiment, the payloads of the current and preceding datagrams are multiplexed at an IP layer of the terminal 110 (as shown in FIG. 1) or, alternatively, at an IP layer of a network edge (discussed in reference to FIG. 3 below).

Generally, header and system fields have substantially greater bit lengths (i.e., bit counts) than the payload fields. For example, a typical payload field comprises 20 bytes of data, whereas the header and system fields may occupy from 40 (IP version 4, without encryption) to 132-389 bytes (IP version 4 with HAIPE). Systems have been proposed in which a transmitting node may append to each data packet redundant copies of the preceding K number of data packets, as described in, for instance U.S. Pat. No. 6,785,261 issued to Schuster et al. on Aug. 31, 2004 entitled “Method and system for forward error correction with different frame sizes.” In this way, the receiving end may readily recover a lost packet D.sub.i from one of the k subsequent packets D.sub.i+1 . . . D.sub.i+k. As more preceding packets are concatenated with each current packet in the stream, the network can then tolerate a higher rate of packet loss. Although such redundant packets systems may be tolerable in low security systems, where the payload field and the header and system fields are of comparable size, they become extremely inefficient if used with encrypted networks such as, for instance, a HAIPE network, where the payload field is a relatively small fraction of the total packet or datagram. In such encrypted networks, it is highly advantageous to use an embodiment of the present invention in which only the payload fields of the preceding packets are multiplexed into the current packet. This requires multiplexing/demultiplexing the payloads at the packet assembly stage using the payload recovery application 116. This multiplexing of the current and preceding payloads, however, has a limited effect on the bit lengths of the datagrams, duration of a time intervals needed for their transmission or reception, or information bandwidth of the system 100, even in encrypted networks such as a HAIPE network.

The datagram having multiplexed payloads, after being optionally encrypted using the encryption/decryption application 118, is wirelessly transmitted and, as such, enters the network 120. A copy of the payload of the transmitted datagram is stored in the buffer 112, where it replaces the copy of the payload of the least recent datagram in the same data train. As such, during transmission of packets corresponding to a respective voice message, each currently transmitted packet contains its own payload and copies of payloads of the pre-determined number of packets transmitted immediately prior to that packet.

The wireless VoIP system 100 may operate under conditions causing interference, delays, jitter, or other factors degrading temporal performance of communication links of the system, and some of transmitted packets (e.g., packets transmitted by the terminal 110_{K}) may be lost, i.e., not received by the intended recipient (e.g., terminal 110₁) or unrecoverably corrupted, as may especially occur in a network utilizing data encryption techniques, such as HAIPE, which discards missing or corrupted data. In the system 100, when a received datagram is separated or de-multiplexed at a receiving terminal (e.g., terminal 110₁), copies of payloads of preceding datagrams may be used to recover, with some delay, the contents of the missing packets.

A number of payloads from the preceding datagrams (i.e., number of the fields 206₁-206_{N}) in the datagram 200 is determined based on a statistically or otherwise defined (e.g., measured) rate of packet losses in the system 100. Generally, from 1 to 3-5 or more copies of such payloads may be combined or multiplexed with the payload of the outgoing datagram. In operation, depending on the experienced rate of the packet losses, the number of multiplexed copies may be changed. In particular, more payloads from the preceding packets copies may be included in the outgoing datagrams when a high rate of packet losses is detected in a specific wireless link of the system 100.

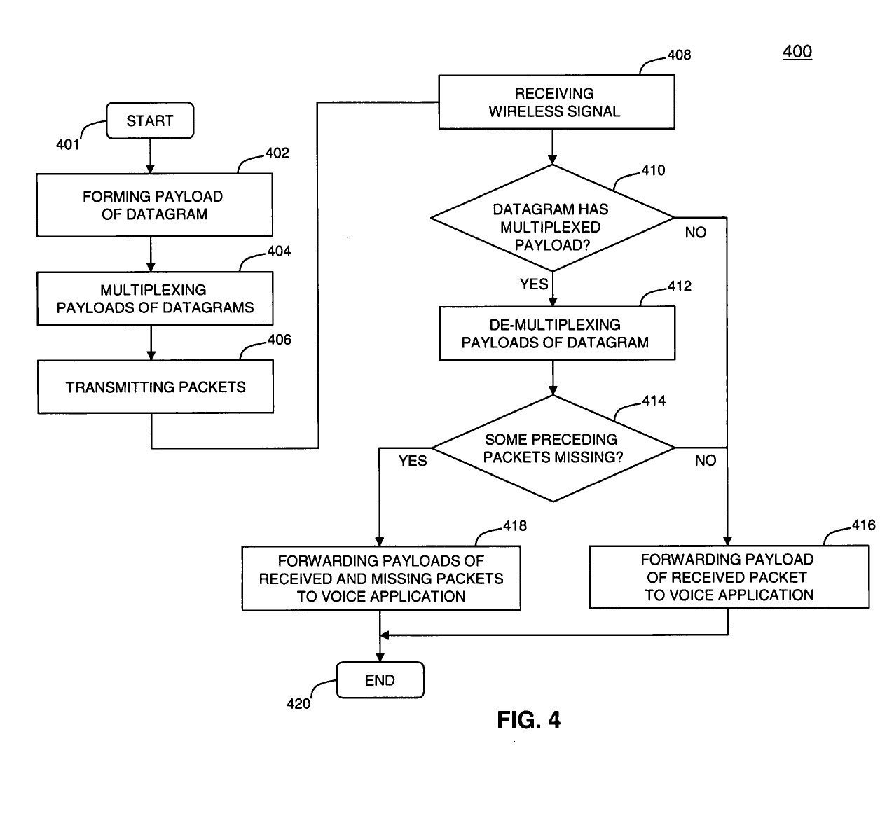

At a receiving terminal, after a datagram of a received wireless signal is decrypted by the encryption/decryption 118, the voice data fields of the datagram (i.e., fields 204 and 206₁-206_{N}) are de-multiplexed, or separated. When it is determined that some of the preceding packets are missing at the receiving terminal, contents of the respective de-multiplexed fields 206₁-206_{N} are forwarded to the voice application 108 and utilized to recover the lost data (discussed in detail in reference to FIG. 4 below). In one embodiment, payloads of the current and preceding datagrams are de-multiplexed, the voice data train is re-assembled to include payloads from the lost packets, and then contents of payloads of the processed and recovered datagrams are forwarded to the voice application 118. Such processing of the packets may be performed, for example, at the IP layer of the terminal 110 (as shown in FIG. 1) or, alternatively, at the IP layer of the network edge (discussed in detail in reference to FIG. 3).

FIG. 3 is a high-level, schematic diagram depicting an exemplary configuration of a software stack 300 of the system 100. In one embodiment, the stack 300 includes a software stack 310 of the terminal 110, a software stack of an optional network edge 320, and a software stack of an encrypted core network 330. The software stack 310 generally includes a voice application layer 302, a UDP or TCP layer 304, an IP layer 306, and an optional encryption/decryption layer 308. Multiplexing/de-multiplexing of payloads of the current and preceding datagrams may be performed at the IP layer 306 of the software stack 310, or, alternatively, at an IP layer 322 of the network edge 320.

The software stack 310 may interface with the network edge 320. In the depicted embodiment, the encryption/decryption layer 308 is associated with the stack 310. Alternatively, the encryption/decryption layer 308 may be associated with the network edge 320, for example, in alternative embodiments where the stack 310 interacts with the encrypted network layer 330 via the network edge 320 (shown with broken lines). In the described embodiments, the encryption/decryption layer 308 operates with the IP-based packets in which payloads have been multiplexed at the IP layer 306 of the stack 310 or, alternatively, at the IP layer 322 of the network edge 320. Such packets are compatible with encryption/decryption techniques that are presently used in VoIP communication systems, such as HAIPE.

FIG. 4 is a flow diagram illustrating a method of wireless VoIP communications in accordance with one embodiment of the present invention. In particular, FIG. 4 depicts a sequence 400 of method steps performed to facilitate reliable wireless communication links between transmitting and receiving terminals of the system of FIG. 1 experiencing a high rate of packet losses. In some embodiments, these method steps are performed in the depicted order. In alternate embodiments, at least two of these method steps may be performed contemporaneously or in a different order.

Illustratively, the method steps of the sequence 400 are presented in an order that corresponds to a transmission of a voice message from one terminal (e.g., terminal 110₁) to another terminal (e.g., terminal 110ₖ). However, in the system 100, such communications, as well as half-duplex or duplex communications, may simultaneously be performed between any and all of the terminals 110. For clarity, the method is discussed in reference to the method steps performed during transmission and reception of one datagram, which is referred to herein as a datagram X. One skilled in the art will readily appreciate that such method steps are cyclically repeated (not shown) for the datagrams of a data train constituting the related voice message. One skilled in the art will further readily appreciate that the method steps of sequence 400 may be employed in other embodiments of the invention, including, but not limited to, wired and fiber-optic terrestrial or undersea networks supporting IP-based voice or data communications, as well as in the networks having a combination of wireless, wired or fiber-optic links, and further including free space optical communication networks, such as a laser-based communication network.

In the depicted embodiment, processing of the voice data fields of the packets and encryption/decryption of the packets are performed using resources of the software stack 310 of the terminal 110. Alternatively, at least a portion of such functions may be performed at the network edge 320 (discussed in reference to FIG. 3 above).

The method starts at step 401 and proceeds to step 402. At step 402, at a transmitting terminal (e.g., terminal 110₁), a payload of the datagram X is formed. In particular, the voice application 108 digitizes a voice message and then payloads for a plurality of packets needed to transmit the voice message are generated using the respective programs of the software stack 310.

At step 404, the payload of the datagram X is multiplexed with copies of payloads of preceding N datagrams. During processing of the preceding packets, such copies were stored in a buffer of payloads (buffer 112). The payload of the datagram X and copies of the payloads of preceding datagrams form the data fields 204 and 206₁-206_{N}, respectively, of a packet to be transmitted to a receiving terminal. A copy of the payload of the datagram X is stored in the buffer, where it replaces a copy of the least recent datagram.

At step 406, the packet containing the payloads multiplexed during step 404 and otherwise compliant with requirements of the communication protocol of the network 120 (e.g., VoIP encrypted using HAIPE), in a form of a wireless signal is transmitted to a receiving terminal. At step 408, the wireless signal is received at the receiving terminal (e.g., terminal 110_{K}), where the packet is converted from a radio-frequency (RF) domain in the digital domain.

At step 410, the method queries if the received datagram (e.g., diagram X) contains multiplexed payloads (i.e., if the datagram has the fields 206₁-206_{N}). If the query of step 410 is negatively answered, the method proceeds to step 416 where the payload of the datagram (i.e., content of the field 204) is forwarded to the voice application 108. If the query of step 410 is affirmatively answered, the method proceeds to step 412 where contents of the payloads' fields of the received datagram are de-multiplexed.

At step 414, the method queries if some or all of the N preceding packets have not been received by the receiving terminal, i.e., lost during in the communication channel. If the query of step 414 is negatively answered, the method proceeds to step 416, where the payload of the received packet is forwarded to the voice application 108. If the query of step 414 is affirmatively answered, the method proceeds to step 418 where the payload of the datagram (i.e., content of the field 204) and copies of payloads of the missing packets (i.e., contents of the respective fields 206₁-206_{N}) are forwarded to the voice application 108. At step 420, the method ends.

In operation, the method facilitates recovery of contents of lost preceding packets and, as such, facilitates VoIP communications over networks having high rates of packet losses. Furthermore, the method is compatible with existing encryption/decryption schemes, including, but not limited to HAIPE, as well as with existing error cancellation methods and FEC techniques. Similarly, the method may also be used in wired and fiber-optic networks to increase reliability of information exchanges realized in a form of data packets (e.g., IP-based data packets).

Although the invention herein has been described with reference to particular illustrative embodiments, it is to be understood that these embodiments are merely illustrative of the principles and applications of the present invention. Therefore, numerous modifications may be made to the illustrative embodiments and other arrangements may be devised without departing from the spirit and scope of the present invention, which is defined by the appended claims.

What is claimed is:

1. A method of information transfer in a packet switched network, comprising:
generating data packets having a payload field and at least one field containing a copy of a payload of at least one preceding packet; and
exchanging information between terminals of the network using said packets.

2. The method of claim 1 wherein the network is in compliance with at least one of an Internet Protocol (IP) protocol, a time division multiple access (TDMA) protocol, the High Assurance Internet Protocol Encryption (HAIPE), or a voice over the Internet (VoIP) protocol.

3. The method of claim 1 wherein the network is a wireless, wired, or fiber-optic communication network or a combination thereof.

4. The method of claim 1 wherein the payload field and said at least one field are processed at an IP layer of a transmitting or receiving terminal of the network or an edge of the network.

5. The method of claim 1 wherein at a receiving terminal of the network contents of the payload field and said at least one field are separated and selectively forwarded to a recipient application.

6. A method of digital communications in a packet switched network, comprising:
transmitting datagrams from a transmitting terminal, each datagram including a payload and a copy of a payload of at least one preceding datagram;
separating the payload of the datagram and the copy of the payload of at least one preceding datagram at a receiving terminal; and
forwarding the payload and the copy of the payload of a missing preceding datagram to an application layer.

7. The method of claim 6 wherein the network is in compliance with at least one of the Internet Protocol (IP), a time division multiple access (TDMA) protocol, the High Assurance Internet Protocol Encryption (HAIPE), or a voice over the Internet (VoIP) protocol.

8. The method of claim 6 wherein the application layer comprises a voice application.

9. The method of claim 6 wherein said communications are performed over at least one wireless, wired, or fiber-optic link of the network.

10. The method of claim 6 further comprising:
forming the datagram at a IP layer of the transmitting terminal or an edge of the network; and
performing the separating step at an IP layer of the receiving terminal or at the edge of the network.

11. A method of wireless voice over the Internet (VoIP) communications, comprising:
at a transmitting terminal:
(a) multiplexing a payload of a datagram and a copy of a payload of at least one preceding datagram; and
(b) transmitting a wireless signal that carries the datagram including the payload and the copy of the payload of at least one preceding datagram; and
at a receiving terminal:
(c) de-multiplexing the payload of the datagram and the copy of the payload of at least one preceding datagram; and
(d) forwarding the payload of the datagram and the copy of the payload of a missing or corrupted datagram from the at least one preceding datagram to a voice application.

12. The method of claim 11 wherein said communications are performed in compliance with at least one of a time division multiple access (TDMA) protocol or the High Assurance Internet Protocol Encryption (HAIPE).

13. The method of claim 11 wherein said communications are performed over at least one wireless link of an Internet Protocol (IP) based communication network.

14. The method of claim 13 further comprising:
performing the step (a) at an IP layer of the transmitting terminal or an edge of the network; and
performing the step (c) at an IP layer of the receiving terminal or the edge of the network.

15. A terminal of a communication network for wireless voice over the Internet (VoIP) communications, comprising:
communication hardware;
a processor unit; and
a memory containing:
a voice application;
a communication application; and
a payload recovery application adapted (a) to multiplex a payload of a transmitted datagram and a copy of a payload of at least one preceding datagram; and (b) to separate the multiplexed payload and the copy of the payload of at least one preceding datagram.

16. The terminal of claim 15 wherein the payload recovery application is implemented at an IP layer of the terminal or an edge of the communication network.

17. The terminal of claim 15 wherein the payload recovery application comprises a buffer of payloads of the datagrams, a multiplexer of the payloads, and a de-multiplexer of the payloads.

18. A system for wireless VoIP communications comprising a plurality of terminals of claim 15.

19. A computer readable medium storing software that, when executed by a processor, causes an Internet Protocol (IP) based network to perform a method, comprising:
generating data packets having a payload field and at least one field containing a copy of a payload of at least one preceding packet; and
exchanging information between terminals of the network using said packets.

20. A computer readable medium storing software that, when executed by a processor, causes a communication network to perform a method, comprising:
transmitting datagrams from a transmitting terminal, each datagram including a payload and a copy of a payload of at least one preceding datagram;
separating the payload of the datagram and the copy of the payload of at least one preceding datagram at a receiving terminal; and
forwarding the payload and the copy of the payload of a missing preceding datagram to an application layer.

21. A computer readable medium storing software that, when executed by a processor, causes a system for wireless voice over the Internet (VoIP) communications to perform a method, comprising:
at a transmitting terminal:
(a) multiplexing a payload of a datagram and a copy of a payload of at least one preceding datagram; and
(b) transmitting a wireless signal that carries the datagram including the payload and the copy of the payload of at least one preceding datagram; and
at a receiving terminal:
(c) de-multiplexing the payload of the datagram and the copy of the payload of at least one preceding datagram; and
(d) forwarding the payload of the datagram and the copy of the payload of a missing or corrupted datagram from the at least one preceding datagram to a voice application.

22. The medium of claim 20 wherein said communications are performed in compliance with at least one of the Internet Protocol (IP), a time division multiple access (TDMA) protocol, the High Assurance Internet Protocol Encryption (HAIPE), or a voice over the Internet (VoIP) protocol.
